(19) United States
(12) Patent Application Publication
(10) Pub. No.: US 2009/0150939 A1
(43) Pub. Date: Jun. 11, 2009

(54) SPANNING MULTIPLE MEDIUMS

(75) Inventors: Steven Drucker, Bellevue, WA (US); James E. Allard, Seattle, WA (US); David Sebastien Alles, Seattle, WA (US); Nicholas R. Baker, Cupertino, CA (US); Todd Eric Holmdahl, Redmond, WA (US); Nigel S. Keam, Redmond, WA (US); Oliver R. Roup, Boston, MA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/950,761

(22) Filed: Dec. 5, 2007

(51) Int. Cl. H04N 5/445

(52) U.S. Cl. 725/59

(57) ABSTRACT

The claimed subject matter relates to an architecture that can facilitate a more robust experience in connection with content consumption. The architecture can span several mediums by way of distinct content channels in order to deliver contextual content and/or media in which a significant event has occurred. Contextual content or other media can be provided simultaneously with the active media, can be synchronized with the active media, and/or can be output to a single or multiple media devices. In addition, media can be appropriated paused while other media is provided and media segments can be recorded for imminent display, such as media segments that include significant events.

### CROSS-REFERENCE TO RELATED APPLICATIONS

This application is related to U.S. application Ser. No. 11/941,305, filed on Nov. 16, 2007, entitled “INTEGRATING ADS WITH MEDIA.” The entirety of this application is incorporated herein by reference.

### BACKGROUND

Conventionally, broadcast media delivered by way of, e.g. a television or other media output device can facilitate in an audience (e.g., content consumers) numerous questions that largely go unanswered due to a variety of reasons that can include an inherent limitations in the use of the platform, structure of the content, as well as an inability to predict the associations made in the mind of a given content consumer. For example, media often alludes to other productions or makes obscure references to people, places, or events in which it is not in the plot line to explain. In other cases, a particular actor, the apparel of the actor, an object or element in the scene, or a location of the set may pique a content consumer's curiosity. Any number of items associated with video media may present numerous opportunities to provide additional information in order to appease a content consumer's curiosity or to provide some form of intellectual gratification. However, conventionally, these opportunities remain largely unexploited.

In a related area of consideration, content consumption is oftentimes coupled to an opportunity cost of sorts. For example, consider an avid sports fan who is interested in several sporting events that are televised simultaneously. While the difficulty of being forced to miss one or several of the games in which the fan is interested can be mitigated somewhat by digital/personal video recorders (DVR/PVR) or other devices that allow delayed media consumption, such devices are not utilized to their full potential. Moreover, other constraints can exist as well such as time or equipment limitations. Ultimately, the sports fan is resigned to switching back and forth between multiple games with the goal of catching exciting plays, while at the same time not missing out on something significant during the search.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can facilitate a more robust experience in connection with content consumption. In accordance therewith, the architecture can identify or characterize media in order to, e.g. provide contextual or other content. Additionally, the architecture can determine or infer a noteworthy occurrence in the media and, depending upon various factors, facilitate a suitable response. To these and other related ends, the architecture can utilize multiple mediums.

According to an aspect of the claimed subject matter, the architecture can interface to a first and a second content channel, wherein at least the first content is adapted for display by a media output device such as a television. The second content channel can be adapted for display by the television or by a disparate output device. The architecture can examine the media included in one or both content channels and, based upon this examination, augment display of the media for one or both content channels, which can be, but need not be, displayed simultaneously.

In one aspect, the architecture can determine a media ID for the media, transmit the media ID to a knowledge base, and receive contextual content that is related to the media based upon this media ID. The contextual content can be displayed on one of the content channels and can be synchronized with the underlying media. In another aspect, the architecture can determine a significant event in connection with media on one of the content channels. When a significant event occurs in the media (e.g., in media that is being monitored or examined, but not necessarily actively consumed by a content consumer), then the architecture can, inter alia, generate an alert to notify the content consumer of the significant event. In other aspects, the architecture can facilitate display of the media in which the significant event occurred, instantiate an application for delivery of the media, modify a size, shape, location, or priority of what is included in the content channels, and/or pause the active media while the aspects of the significant event are provided to the content consumer.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can facilitates a more robust experience in connection with content consumption.

FIG. 2 depicts a block diagram of a system that can identify or characterize media in order to facilitate a more robust experience in connection with content consumption.

FIG. 3 is a block diagram of a system that can identify noteworthy occurrences in connection with displayed media order to facilitate a more robust experience in connection with content consumption.

FIG. 4 illustrates a block diagram of various examples of a significant event.

FIG. 5 depicts a block diagram of a system that can aid with various inferences.

FIG. 6 is an exemplary flow chart of procedures that define a method for facilitating a richer content consumption environment.

FIG. 7 illustrates an exemplary flow chart of procedures that define a method for identifying and/or characterizing media in order to facilitate a richer content consumption environment.

FIG. 8 depicts an exemplary flow chart of procedures defining a method for identifying noteworthy occurrences in connection with presented media in order to facilitate a richer content consumption environment.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

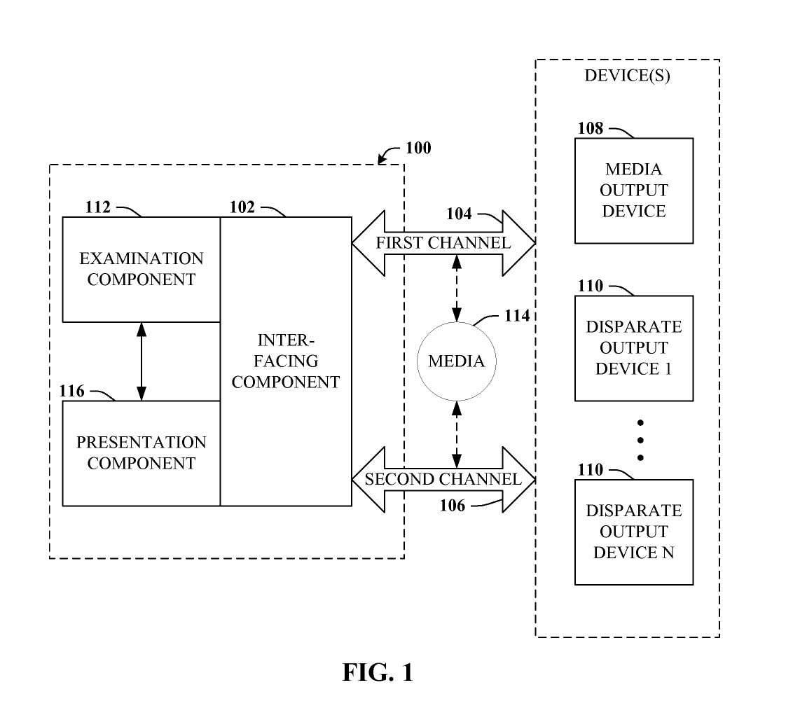

Referring now to the drawings, with reference initially to FIG. 1, system 100 that can facilitate a more robust experience in connection with content consumption is depicted. Generally, system 100 can include interfacing component 102 that can be configured to operatively couple to first content channel 104 and to second content channel 106, wherein at least first content channel 104 is adapted for display on media output device 108. Similarly, second content channel 106 can also be adapted for display on media output device 108, however, in some cases, second content channel 106 can be adapted for display on one or more disparate output device(s) 110. In either case, whether media output device 108 is adapted to display both first content channel 104 and second content channel 106 or only first content channel 104, it is to be appreciated that content channels 104 and 106 can be, but is not required to be, displayed simultaneously.

Media output device 108 as well as disparate output device 110 can be substantially any type of media device with an associated output mechanism that can provide a media presentation and/or facilitate consumption of media/content. Examples of media output device 108 (and/or disparate output device 110) can include, but need not be limited to a television, monitor, terminal, or display, or substantially any device that can provide content to such devices, including, e.g., cable or satellite controllers, a digital versatile disc (DVD), digital video recorder (DVR), or other media player devices, a personal computer or laptop, or component thereof (either hardware or software), media remotes, and so on.

While media output device 108 or disparate output device 110 can potentially be any of the above-mentioned devices as well as others, one common scenario that will be routinely referred to herein is the case in which media output device 108 is a television and disparate output device 110 is a laptop. In accordance therewith, first content channel 104 can be adapted for display on the television (e.g., media output device 108), while second content channel 106 can be adapted for display on or by the laptop. However, in some aspects, both the content channels 104, 106 can be adapted for display on the television. Such can be accomplished by way of well-known picture-in-picture technology that allocates different portions of the screen to different content channels, or, in addition or in the alternative, based upon an different technology altogether, such as displaying multiple views simultaneously wherein each view potentially employs the entire surface of the screen, but is substantially visible only when observed from a particular range of observation angles. In either case, is should be underscored that first content channel 104 and second content channel 106 can be synchronized.

Additionally, it should also be noted that, conventionally, the television and the laptop are unrelated mediums for content and often provide or require distinct formats in connection with the content or media. However, in connection with the claimed subject matter both of these mediums can work together to provide a more robust experience in connection with content consumption, which is further detailed infra.

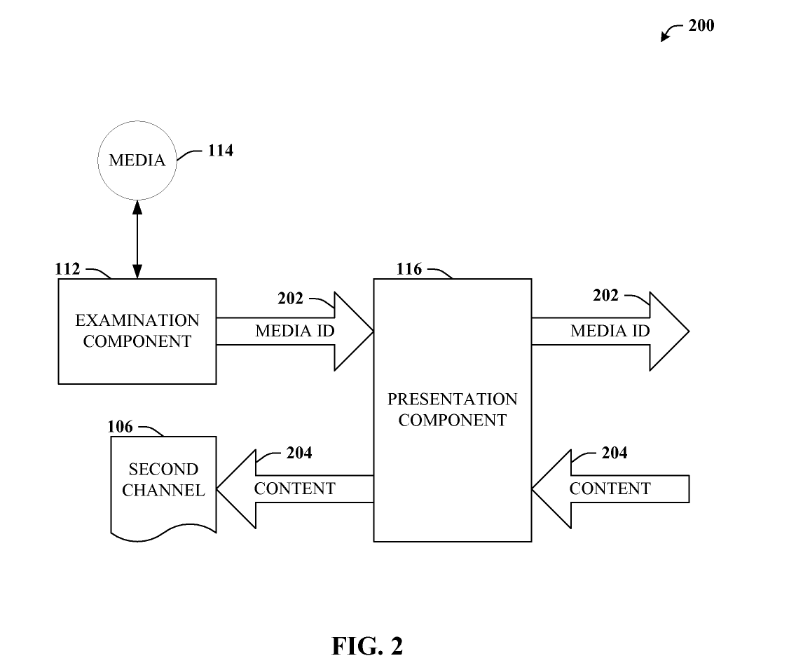

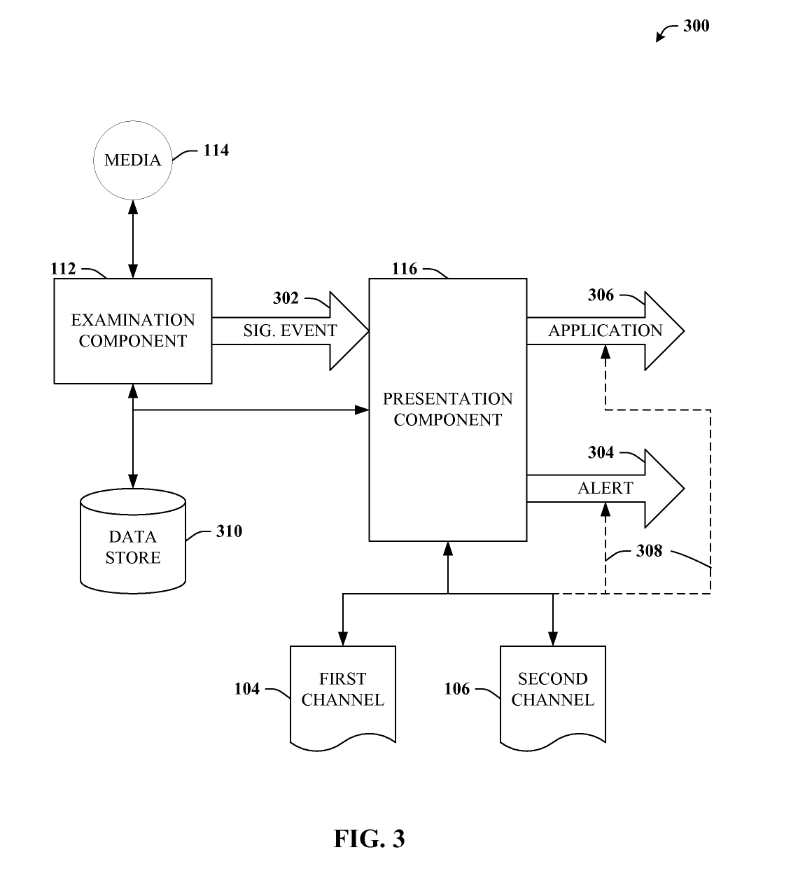

Still referring to FIG. 1, system 100 can also include examination component 112 that can monitor media 114 included in first content channel 104 or second content channel 106. Further discussion with respect to examination component 112 is presented in connection with FIGS. 2 and 3, infra. However, as a brief introduction, examination component 112 can monitor features or objects of media 114, can monitor events associated with media 114, can monitor data, metadata, or special metadata associated with media 114 and so forth.

Media 114 is intended to encompass all or portions of media/content that can be delivered to output devices 108, 110, generally by way of content channels 104, 106 (to which interfacing component 102 can be operatively coupled). However, it is to be appreciated that media 114 delivered by way of first content channel 104 can have distinct features from media 114 delivered by way of second content channel 106. Thus, while in both cases, the media/content can be referred to as media 114, where distinction is required, useful or helpful, such will be expressly called out unless the distinctions are already reasonably clear from the context.

In addition, system 100 can also include presentation component 116 that can augment display or the arrangement of media 114 displayed from first content channel 104 or second content channel 106. Additional discussion with respect to presentation component 116 can be found in connection with FIGS. 2 and 3, infra. Yet, as an introductory explanation, presentation component 116 can augment display of media 114 by providing contextual content in connection with media 114, synchronizing display of media 114 (e.g., synchronizing between content carried on content channels 104, 106), activating second content channel 106 or media presented by way of second content channel 106, update the size or position of media 114 carried by content channels 104, 106, launch associated applications, and the like.

Turning now to FIG. 2, system 200 is illustrated that can identify or characterize media in order to facilitate a more robust experience in connection with content consumption. Typically, system 200 can include examination component 112 that can monitor media 114 that can be included in content channels 104, 106. In addition, examination component 112 can be configured to determine media ID 202 in connection with media 114 that can be included in first content channel 104. Media ID 202 can specifically identify media 114 such as indicating that media 114 is a specific production (e.g. a specific television show, feature film, commercial/advertisement, etc.), or media ID 202 can identify a category of media 114 (e.g., comedy, sports, drama, news, romance, or a category for a television show, feature film, commercial/advertisement, etc.). In some cases, media ID can be included with media 114 itself such as included in header fields, metadata, special metadata or the like, while in other cases, examination component 112 can dynamically determine or infer the media ID 202 based upon text and/or closed captions, facial recognition techniques, speech recognition techniques and so forth.

Additionally, system 200 can include presentation component 116 that can augment display of media 114 for content channels 104, 106. Furthermore, presentation component 116 can transmit media ID 202 (e.g., to a knowledge base, data store, and/or cloud/cloud service), and can receive contextual content 204 related to media 114. Contextual content 204 can be additional information or advertisements relating to elements, features, objects, or events included in media 114 displayed by way of first content channel 104. In accordance therewith, presentation component 116 can provide all or portions of contextual content 204 to second content channel 106. In addition, presentation component 116 can ensure that contextual content 204 is synchronized with a presentation of media 114.

As one example illustration of the foregoing, consider a content consumer who is watching television (e.g., media output device 108) and intermittently doing work related activities on a laptop (e.g., disparate output device 110). In particular, the content consumer is viewing an episode of a familiar comedy program that is well-known to routinely make obscure references. The examination component 112 can determine or infer media ID 202 for the comedy program (either specifically such as the program name, episode number, etc. or a category such as, e.g., comedy series). Based upon this determination, presentation component 116 can receive contextual content 204, which can vary depending upon whether or not media ID 202 is specific to the program or more generally relates to a category for the program.

In cases where media ID 202 specifically identifies the comedy program, contextual content 204 can be very specific information such as an explanation of an obscure reference. Such information can be provided by or in association with the authors or producers of the comedy program and can therefore be available before or as the program airs on television. In cases in which media ID 202 identifies categorical information, other types of contextual content 204 might be more suitable or more readily available such as bios or other information about actors appearing in the program (potentially determined from facial recognition techniques, for example), information on the program itself such as cast, crew, set, history, etc., information relating to elements, features, or objects in the program, information relating events occurring in the program and so forth.

Regardless of the actual composition, contextual content 204 can be delivered to the laptop by way of second content channel 106. For example, contextual content 204 can be provided by a suitable browser, media player, or other application running on the laptop. Additionally, contextual content 204 can be synchronized with the comedy program presented on the television such that appropriate contextual content 204 can be provided at suitable moments during the show. For instance, suitable contextual content 204 can be queued up for presentation or display and activated based upon time stamp information included in the comedy program. Additionally or alternatively, contextual content 204 can be selected on the fly based upon elements or events identified in the comedy program.

Moreover, only portions of contextual content 204 need be presented at any given time. For example, the laptop can display a small gadget, ticker, or bug that provides links to other portions of contextual content 204. Accordingly, the content consumer can intermittently perform work related tasks while watching the comedy show, and occasional address the display that includes portions of contextual content 204. If the content consumer so desires, the aforementioned links can be accessed (e.g., by clicking the links) and more in-depth contextual content 204 can be supplied either directly in the gadget, by launching a suitable application, or another suitable manner.

It is to be understood that the foregoing is intended to be merely illustrative and other aspects can be included within the scope of the appended claims. For example, disparate output device 110 need not be a laptop just as media output device 108 need not be a television. Moreover, second content channel 106 need not be interfaced with disparate output device 110, and can instead interface media output device 108, wherein media output device 108 is configured to provide media 114 from both content channels 104 and 106, which can potentially be synchronized as well as simultaneous.

With reference now to FIG. 3, system 300 that can identify noteworthy occurrences in connection with displayed media order to facilitate a more robust experience in connection with content consumption is provided. In general, as with previous aspects, system 300 can include also include examination component 112 that can monitor media included in content channels 104, 106 and presentation component 116 that can augment display of media 114 for content channels 104, 106 as substantially detailed supra.

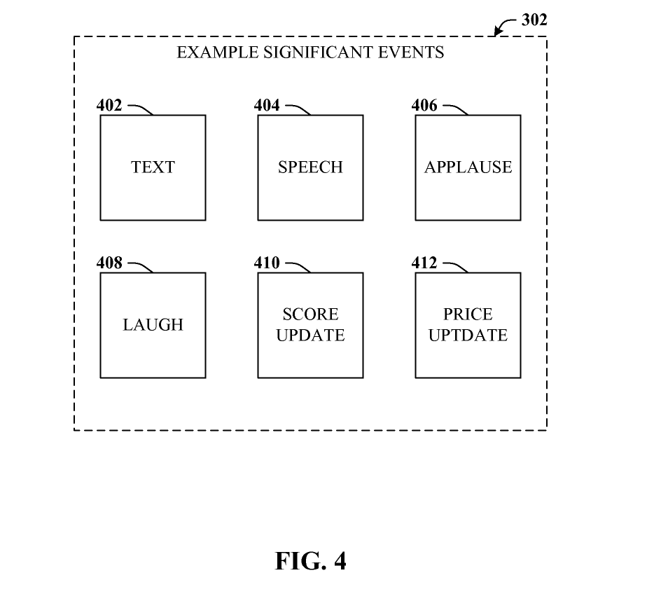

In addition to or in accordance with what has previously been described, examination component 112 can be configured to determine significant event 302 in connection with media 114. For example, presentation of media 114 (e.g., presented to a content consumer by a television or other media output device 108 by way of first content channel 104) can sometimes result in a noteworthy occurrence (e.g., significant event 302). For example, referring again to the aforementioned comedy program, significant event 302 can be the occurrence of an obscure reference, which can prompt further features, such as an endeavor to explain the obscure reference. Another example significant event 302 can be the appearance of a particular element or object such as a car promoted by a certain advertiser. Still another example significant event 302 can be a scoring play in a sports telecast. Numerous additional example significant events 302 are provided in connection with FIG. 4, infra, however, it is readily appreciable that, regardless of the particular character or nature, significant event 302 can be a natural catalyst for providing contextual content 204 or performing some other suitable action.

In order to provide additional context, FIG. 4 can now be referenced before completing the discussion of FIG. 3. While still referring to FIG. 3, but turning also to FIG. 4, various examples of significant event 302 are provided. As an initial example, significant event 302 can be substantially any text 402 or speech 404, but will generally be specific key words or terms. For example, a commentator might say the words/phrases “he scores” or “touchdown,” either of which can be a significant event 302. It should be appreciated that examination component 112 can identify such words/phrases based upon speech recognition or based upon text recognition, as media 114 often provides with the presentation closed captioned text 402 associated with all or portions of speech 404. It should also be appreciated that examination component 112 can determine whether or not text 402 or speech 404 is significant event 302 based upon a category of media 114 or based upon media ID 202. For instance, the word “touchdown” will often be significant event 302 when media 114 is a, e.g. a live broadcast of a football game, but might not be significant event 302 when media 114 is a highlights reel or news program that is recapping the football game or another program in which the context indicates the text 402 or speech 404 is less significant.

It should also be appreciated that examination component 112 can utilize various features of speech 404 such as tone of voice, pitch, or excitement level to determine significant event 302. Accordingly, examination component 112 can distinguish the relevance of the word touchdown in the same broadcast when it occurs in different contexts. For instance, “the athlete scored a touchdown earlier in the game” can be materially distinct from “he's going deep—touchdown!” And in either case, such can be determined from the differences in context between the statements as well as from an excitement level of the announcer's voice.

Significant event 302 can also be, e.g. a joke, comedy routine, or humorous occurrence. These aspects can be determined, but can also be more difficult to determine, based upon text 402 or speech 404. Accordingly, Examination component 112 can also utilize applause 406 or laughter 408 to determine significant event 302 or as an indication of significant event 302. For example, comedy programs often have a live audience (or sometimes this feature is manufactured to provide the appearance of a live audience). In either case, the live audience can be useful in providing queues to the television audience, generally in the form of applause 406 or laughter 408, but in other ways as well. Such queues (e.g., applause 406 or laughter 408) can be utilized by examination component 112 to determine significant event 302.

Still another example significant event 302 can be a score update 410, a price update 412, or another data update. For example, media 114 can again be a sporting telecast, which often includes a scoreboard feature (e.g., a persistent display or bug at the top portion of the presentation). When this feature presents a score update 410, such can be indicative of significant event 302. Likewise, media 114 can also be news or more specifically financial news covering financial securities. Such media 114 commonly includes a ticker for stock market (or other markets) prices. Certain price updates 412 to these tickers, which can be specified and/or programmed by a content consumer, can represent significant event 302.

Appreciably, many other types of data updates can represent significant event 302. Moreover, significant event 302 need not relate to media 114 that is presently being displayed. Therefore, a content consumer need not be actively viewing the aforementioned sports, comedy, or news programs for these programs to generate significant event 302. Rather, the content consumer can, e.g. select these programs for monitoring and allow examination component 112 to determine when something occurs that might be interesting or of use to the content consumer. Furthermore, as noted supra, significant event 302 need not be specific to televised media 114. Rather, media 114 can relate to, for example, an Internet auction and data a update signifying that the content consumer has been outbid in the auction can be significant event 302.

While conventional mechanisms exist to inform the Internet auction bidder of such an occurrence (e.g., an email notification or the like), in accordance with the claimed subject matter, one distinction over such conventional mechanisms can be that significant event 302 can be propagated by way content channels 104, 106 to output devices 108, 110. Thus, for instance, a content consumer can be watching the game, a comedy or news program, or substantially any media 114 that is unrelated to the Internet auction, yet receive an instant indication of such, say, in the bottom, left corner of the television screen. Such features as well as others are discussed in more detail in connection with presentation component 116, infra.

While still referring to FIG. 3, system 300 can also include presentation component 116 that can augment display of media 114 for content channels 104, 106. In accordance with the foregoing, it is to be appreciated that presentation component 116 can augment display of media 114 based upon significant event 302. In an aspect of the claimed subject matter, presentation component 116 can generate alert 304, which can be an indication that significant event 302 has occurred. According to another aspect, presentation component 116 can launch application 306, which can also be an indication that significant event 302 has occurred as well as a medium by which significant event 302 (or the underlying portion of media 114) can be communicated to the content consumer. Appreciably, both alert 304 and application 306 can be propagated (as indicated by the broken lines at reference numeral 306) by way of either or both the first content channel 104 or second content channel 106.

In yet another aspect of the claimed subject matter, presentation component 116 can activate second content channel 106 based upon significant event 302. For instance, a content consumer can be actively utilizing one media output device 108 such as a television that receives media 114 by way of first content channel 104 and presentation component 116 can activate second content channel 106 to provide an indication of significant event 302. Accordingly, second content channel 106 can output to the television or to disparate output device 110. In connection with the above or other features described herein, presentation component 116 can also pause media 114 provided by way of first content channel 104 when, e.g. second content channel 106 is activated. Therefore, a content consumer watching television or playing a video game can have the program or game paused in order to receive alert 304, application 306, or other media 114 that can potentially be supplied by second content channel 106.

It is to be understood, that while significant event 302 can in many cases be known in advance (e.g., synchronized contextual content 204 provided by, say, the content author) in many cases, significant event 302 cannot be identified until after it has occurred in the broadcast of media 114. However, this need not unduly affect dissemination of significant event 302 (or of the underlying media segment that prompted significant event 302), as media 114 can be recorded and saved to data store 310. Such is commonly done by output device 108, 110 such as a DVR that records media 114 and allows the content consumer to recall media 114 at a later time. Data store 310 can include all media 114 as well as other relevant data such as media ID 202, contextual content 204, etc. Thus, presentation component 116 can be apprised of significant event 302, generate alert 304 and/or application 306, and also obtain from data store 310 the underlying media 114 that prompted significant event for, if necessary or desired, display to the content consumer. Thus presentation component 116 can provide a recorded segment of media 114 relating to significant event 302 in connection with, e.g. alert 304.

Furthermore, according to another aspect of the claimed subject matter, presentation component 116 can modify a size, shape, or location of media 114 displayed on one or more output device(s) 108, 110 based upon significant event 302. Such a modification will generally apply to media 114 displayed upon media output device 108, however, it should be understood that the foregoing can apply to disparate output device 110 as well.

In order to provide additional context, but not necessarily to limit the scope of the appended claims, consider the following examples. If significant event 302 is determined based upon the aforementioned obscure reference (in connection with the comedy program), or determined associated in some way with contextual content 204, then one result can be that presentation component 116 modifies media 114 displayed by way of second content channel 106 on, e.g., disparate output device 110. This can be, e.g. media 114 or other content that describes or explains the obscure reference or a link or reference to such content available by way of the content consumer's laptop.

As another example, consider the case in which the content consumer is watching one football game, but is interested in several, or, alternatively, playing a video game, but interested in the outcome of a football game. If significant event 302 is determined based upon text 402 or speech 404 that indicates, say, a touchdown has occurred in one of the secondary football games, then presentation component 116 can, e.g. automatically switch the display of media output device 108 to the secondary game where significant event occurred and display the scoring play, which was e.g. saved to data store 310. A number of variations can, of course, exist. For example, if media output device 108 is, say, a television capable of such, content consumer might be watching multiple games at one time, with the game most interesting to the content consumer being allocated the most space on the screen, and one or more secondary games allocated smaller amounts of real estate. When significant event 302 occurs in one of the secondary games, presentation component 116 can modify the size, shape, or location of one or all of these games such that, e.g. the secondary game can occupy the largest portion of the screen while significant event 302 is displayed.

It is to be appreciated and understood that in any of the above examples, or in many other cases entirely, alert 304 can be generated and communicated to the content consumer to, e.g., provide a brief synopsis of significant event 302, to determine whether or not the content consumer wants to be presented media 114 associated with significant event 302, and/or for other purposes. Additionally, in all or some of the above examples, presentation component 116 can also instantiate application 306 to facilitate providing media 114 associated with significant event 302. Moreover, in potentially any of the above examples, media 114 can be delivered by way of one or both content channels 104, 106 to one or more output devices 108, 110. Furthermore, it should also be underscored that, according to an aspect of the claimed subject matter, presentation component 116 can also provide for and/or facilitate pausing the active media 114 prior to displaying the secondary media 114 associated with significant event 302. Thus, the video game or primary football game that was active prior to the scoring play in the secondary game that was determined to be significant event 302 can be temporarily paused or suspended, then subsequently returned to without any loss of continuity.

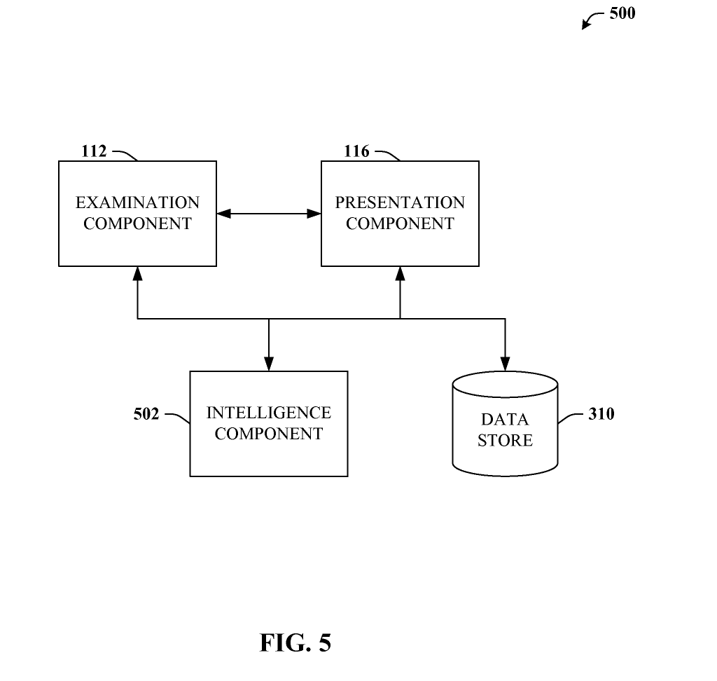

Turning now to FIG. 5, system 500 that can aid with various inferences is depicted. In general, system 500 can include examination component 112 and presentation component 116 as substantially described herein. As noted supra, components 112 and 116 can make various determinations or inferences in connection with the claimed subject matter. For example, examination component can intelligently identify a media category for media 114 such as when determining media ID 202. Likewise, examination component 112 can also, e.g. intelligently determine whether a word or term (such as that included in text 402 or speech 404) constitutes significant event 302. Similarly, presentation component 116 can intelligently select contextual content 204 that is suitable or appropriate based upon media 114 and/or intelligently determine the parameters or when it is necessary, useful, or beneficial to modify the shape, size, or location of media 114 (e.g., based upon user settings, interaction or transaction histories, relevance indicators, and so on).

In addition, system 500 can also include intelligence component 502 that can provide for or aid in various inferences or determinations. It is to be appreciated that intelligence component 502 can be operatively coupled to all or some of the aforementioned components. Additionally or alternatively, all or portions of intelligence component 502 can be included in one or more of the components 112 116. Moreover, intelligence component 502 will typically have access to all or portions of data sets described herein, such as data store 310, and can furthermore utilize previously determined or inferred data.

Accordingly, in order to provide for or aid in the numerous inferences described herein, intelligence component 502 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

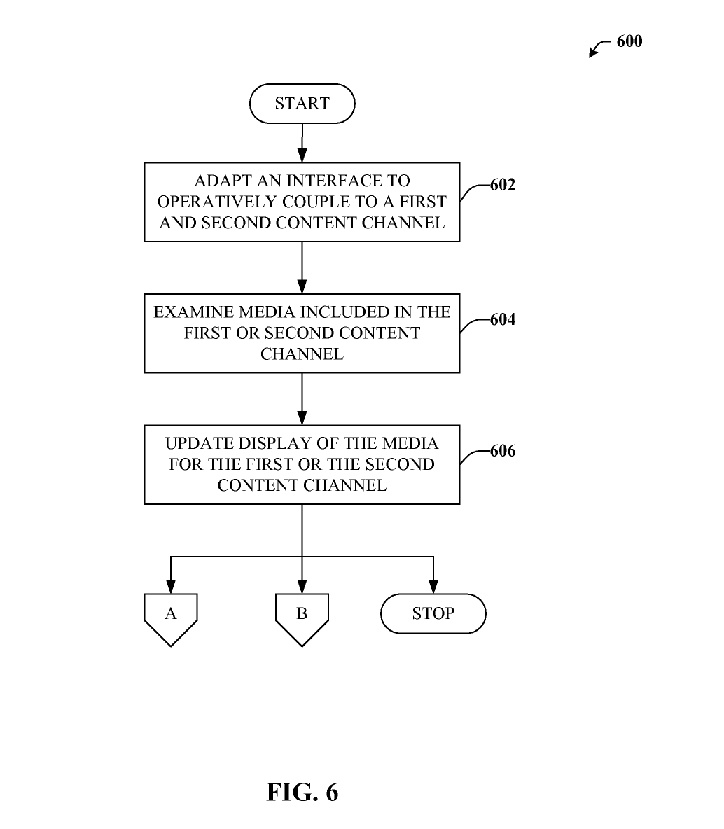

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 6, exemplary method 600 for facilitating a richer content consumption environment is illustrated. Generally, at reference numeral 602, an interface can be adapted to operatively couple to a first content channel and a second content channel, wherein at least the first content channel can be configured for displaying by a media output device. It is to be understood that the second content channel can also be configured for display by the media output device or by a disparate output device. Moreover, in either case, media displayed by way of both content channels can be displayed simultaneously. In some situations, such as when both content channels are displayed by a single media output device, the case can exist in which the content channels are displayed in sequence, one after the other rather than displayed simultaneously.

At reference numeral 604, media included in the first content channel or the second content channel can be examined. For example, the media can be examined in order to determine a media ID, in order to determine the occurrence of a significant event, or for various other related reasons, many of which are detailed herein. It should be appreciated that the determination of the media ID can be based upon express indicia included in the media (e.g., metadata, special metadata . . . ) or based upon an inference associated with the media or a category for the media. Similarly, the determination of the significant event can be expressly called out by portions of the media or intelligently inferred based upon the examination.

At reference numeral 606, display of the media for one of the first content channel or the second content channel can be updated. In accordance therewith, the media presented by one or both of the content channels can be visibly altered or rearranged. Such an act can be based upon a predefined setting or, as with act 604, can be intelligently inferred based upon data available at the time.

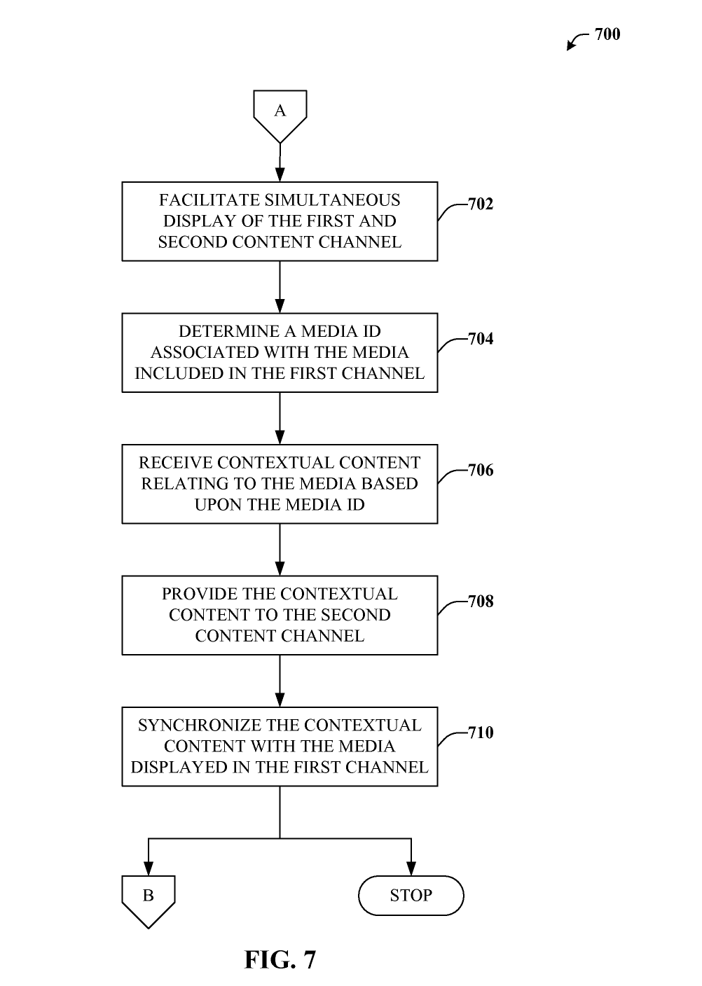

Referring to FIG. 7, exemplary method 700 for identifying and/or characterizing media in order to facilitate a richer content consumption environment is depicted. In general, at reference numeral 702, simultaneous display of the first content channel and the second content channel can be facilitated. Such an act can be accomplished by employing a single media output device or in the trivial case by employing one or more disparate output device(s). For example, in the case in which only a single media output device is employed, both content channels can be displayed simultaneously in different portions of the media output device.

At reference numeral 704, a media ID can be determined for associated media included in the first content channel. It should be understood that the media ID can specifically identify the media by way of title, episode, date, and/or another unique identifier, potentially based upon a formatting scheme of a remote or central database. In addition or in the alternative, the media ID can more broadly identify a media category for the media such as, e.g. a documentary, a series, a comedy, a romance, sports, news, a web-based application, and so forth. It should be further understood that the determination of the media ID can be based upon express information included in the media, or based upon an inference in association with examination of the media.

At reference numeral 706, contextual content relating to the media can be received based at least in part upon the media ID. For instance, the media ID can be transmitted to a remote storage facility and/or service and receive in response contextual content relating to that particular media ID. If the media ID is not specific, but more categorical, then the associated contextual content can be more categorical as well. The contextual content can, e.g., explain an obscure reference, provide further data on cast or crew, provide links or references to further data, provide an advertisement or additional information with respect to an object or element in the media, and so on.

At reference numeral 708, the contextual content can be provided to the second content channel. As such, the contextual content can be displayed by way of the media output device or a disparate output device. At reference numeral 710, the contextual content can be synchronized with the media displayed by way of the first content channel. Hence, both content channels can be synchronized, with the first channel displaying the media and the second channel displaying the contextual content. As one example, such can be accomplished based upon timestamp information and/or other timing-based metadata included in the media and employed to synchronize the contextual content.

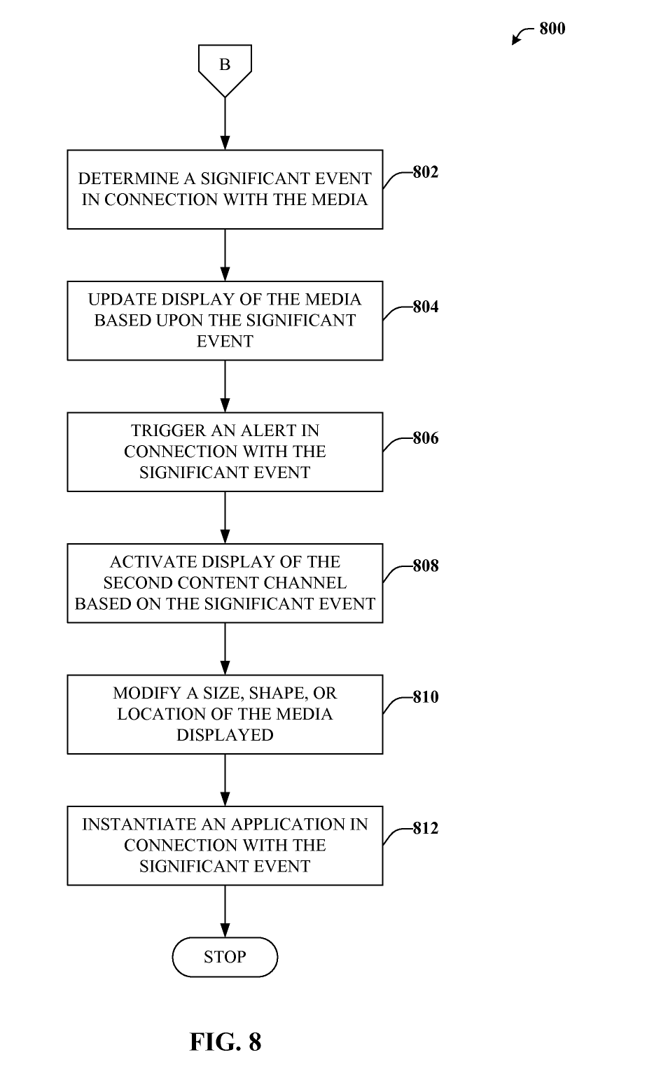

With reference now to FIG. 8, method 800 for identifying noteworthy occurrences in connection with presented media in order to facilitate a richer content consumption environment is illustrated. Generally, at reference numeral 802, a significant event in connection with the media can be determined. The significant event can be an occurrence in the underlying media that a media consumer may be interested in. Moreover, the significant event can relate to media that is presented by the media output device and/or being actively consumed by a content consumer. In addition or in the alternative, the significant event can relate to media that is not presented by the media output device and/or not being actively consumed by the content consumer. In accordance therewith, the significant event can be an appearance of a particular element or object such as a particular actor or apparel worn by the actor and/or promoted by a certain advertiser, scoring play in a sports telecast, an update to a score, price, or other data, or substantially any potentially interesting occurrence or occurrence that can prompt useful features to be provided to the content consumer.

At reference numeral 804, display of the media can be updated based upon the significant event. In particular, the media can be updated by, e.g., providing contextual content or a link or reference to contextual content. Such an update can be accomplished by way of the second content channel displayed to the one or more media output device(s). At reference numeral 806, an alert can be triggered in connection with the significant event. For example, the alert can be provided to notify a content consumer that contextual content or other information is available. The alert can also be provided by way of the first or the second content channel and can be presented to one or more media output device(s).

At reference numeral 808, a size, shape, or location of the media can be modified based upon the significant event. In particular, contextual content and/or disparate content potentially unrelated to the active (e.g., displayed or presented) content can be displayed. In connection with the foregoing, the actively presented content can be moved or reduced. It should be understood that the actively presented content can be paused as well. At reference numeral 810, an application can be instantiated in connection with the second content channel. For instance, display of the contextual content and/or other media potentially related to the significant event can be provided by way of the application.

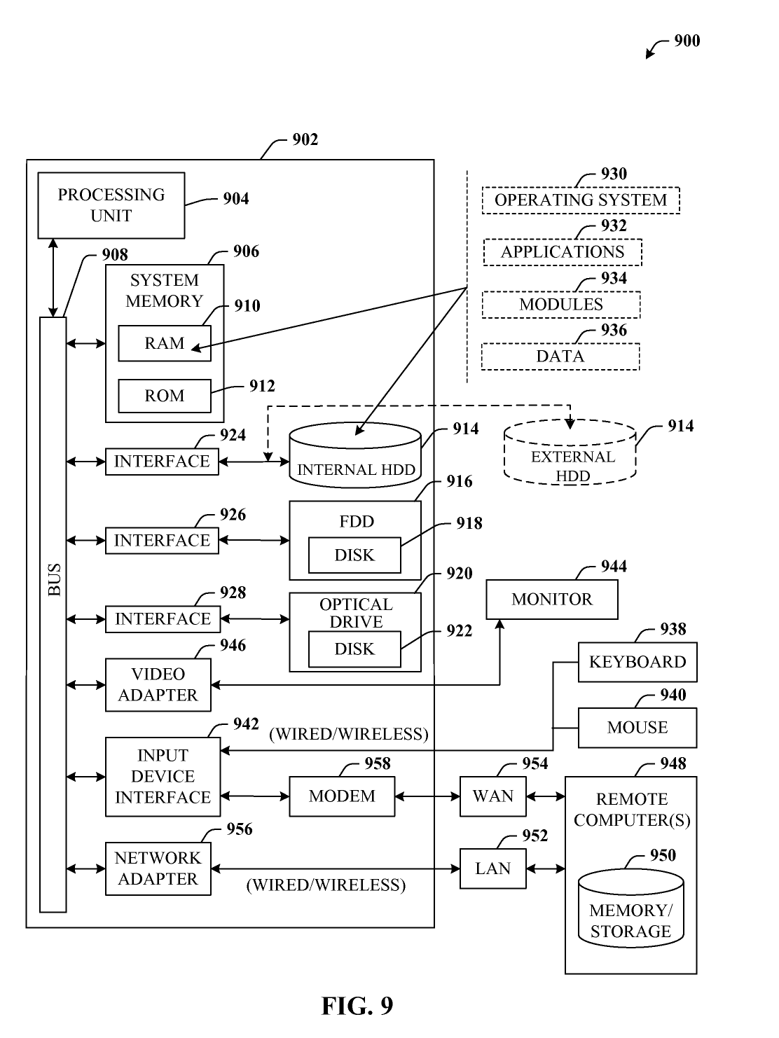

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

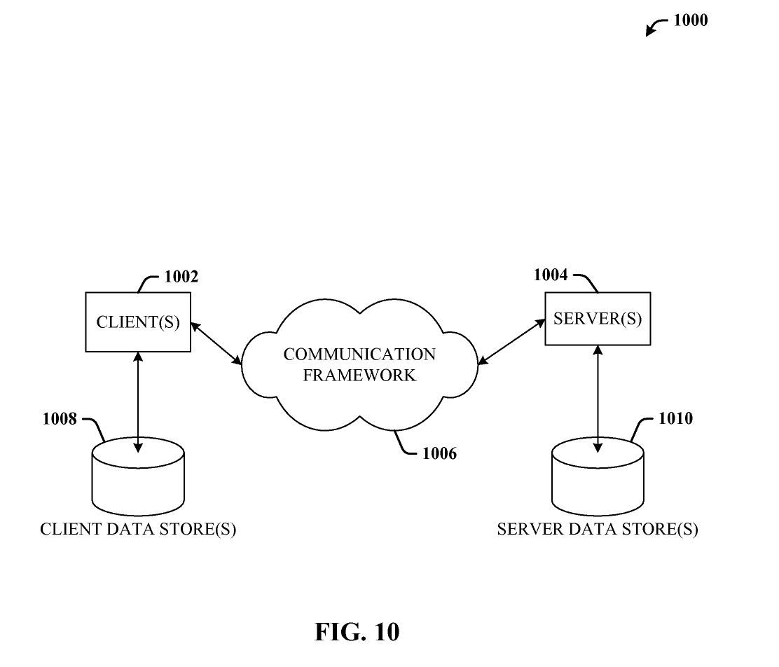

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates a more robust experience in connection with content consumption, comprising:
an interfacing component that is configured to operatively couple to a first content channel and a second content channel, at least the first content channel is adapted for display on a media output device;
an examination component that monitors media included in the first or the second content channel; and
a presentation component that augments display of the media for the first or the second content channel.

2. The system of claim 1, the first content channel and the second content channel are both displayed on the media output device.

3. The system of claim 1, the second content channel is displayed on a disparate media output device.

4. The system of claim 1, the first content channel and the second content channel are displayed simultaneously.

5. The system of claim 1, the examination component is configured to determine a media ID in connection with the media included in the first content channel.

6. The system of claim 5, the media ID specifically identifies the media or identifies a category of the media.

7. The system of claim 5, the presentation component transmits the media ID and receives contextual content related to the media.

8. The system of claim 7, the presentation component provides the contextual content to the second content channel.

9. The system of claim 7, the contextual content is synchronized with the media.

10. The system of claim 1, the examination component is configured to determine a significant event in connection with the media.

11. The system of claim 10, the significant event is determined based upon at least one of a media ID, contextual content, text or voice recognition, a tone, pitch, or excitement level, applause or laughter, a score, price, or other data update.

12. The system of claim 10, the presentation component augments display of the media based upon the significant event.

13. The system of claim 12, the presentation component generates an alert in connection with the significant event, and/or provides a recorded segment relating to the significant event in connection with the alert.

14. The system of claim 12, the presentation component activates the second content channel based upon the significant event, and/or pauses the media provided by the first content channel.

15. The system of claim 12, the presentation component modifies a size, shape, or location of the media displayed based upon the significant event.

16. The system of claim 1, the presentation component launches an application in connection with the first content channel or the second content channel.

17. A method for facilitating a richer content consumption environment, comprising:
adapting an interface to operatively couple to a first content channel and a second content channel, the first content channel is configured for displaying by a media output device;
examining media included in the first content channel or the second content channel; and
updating display of the media for one of the first content channel or the second content channel.

18. The method of claim 17, further comprising at least one of the following acts:
facilitating simultaneous display of the first content channel and the second content channel;
determining a media ID associated with the media included in the first content channel, the media ID specifically identifying the media or identifying a media category;
receiving contextual content relating to the media based at least in part upon the media ID;
providing the contextual content to the second content channel; or
synchronizing the contextual content with the media displayed by way of the first content channel.

19. The method of claim 17, further comprising at least one of the following acts:
determining a significant event in connection with the media;
updating display of the media based upon the significant event;
triggering an alert in connection with the significant event;
activating display of the second content channel based upon the significant event;
modifying a size, shape, or location of the media displayed based upon the significant event or
instantiating an application in connection with the second content channel.

20. A system for facilitating a richer experience in connection with content consumption, comprising:
means for configuring an interface to operatively couple to a first content channel and a second content channel, the first content channel is adapted for displaying by a media output device and the second content channel is adapted for displaying by the media output device or a disparate media output device;
means for monitoring media included in the first content channel or the second content channel; and
means for modifying display of the media for one of the first content channel or the second content channel.
